(19) United States
(12) Patent Application Publication
(10) Pub. No.: US 2011/0136429 A1
(43) Pub. Date: Jun. 9, 2011

(54) VEHICULAR WIRELESS PAYMENT AUTHORIZATION METHOD

(75) Inventors: Michael B. Ames, Lake Orion, MI (US); Dennis J. Gonzales, Southfield, MI (US); Donald K. Grimm, Utica, MI (US)

(73) Assignee: GM GLOBAL TECHNOLOGY OPERATIONS, INC., Detroit, MI (US)

(21) Appl. No.: 12/631,680

(22) Filed: Dec. 4, 2009

(51) Int. Cl. H04B 5/00; G06F 17/00

(52) U.S. Cl. 455/41.1; 235/382; 345/173; 235/380

(57) ABSTRACT

A method and system for making payments from a vehicle using onboard wireless communication systems. A Near Field Communication (NFC) reader is placed a vehicle, such that a customer can pass an NFC-enabled phone or credit card near the reader to provide a source of funding for a purchase. A Dedicated Short Range Communications (DSRC) radio onboard the vehicle communicates with a seller of products or services, such as a fast food restaurant, a parking garage, or a toll booth. The seller communicates to the vehicle the amount of a pending payment, the customer approves the payment within the vehicle, and the vehicle sends the authorization to the seller. The entire transaction is handled wirelessly, without the customer having to leave the vehicle or roll down a window. Pre-approval accounts can also be established for certain types of payments, thus making those payment transactions automatic.

### BACKGROUND OF THE INVENTION

1. Field of the Invention

This invention relates generally to using wireless communications systems onboard vehicles to automatically handle payment transactions and, more particularly, to a method and system for making payments for toll roads, parking, fast food, or other products or services, from a vehicle using a combination of short range communication technology, such as dedicated short range communications (DSRC), Wi-Fi, etc., with very-short range technology, such as near field communications (NFC), RFID, etc., and other wireless technologies.

2. Discussion of the Related Art

Short-range wireless communication technology is commonly used to make it fast and easy for a customer to pay for a product or service. One example of this is a contactless “smart” credit card which can make a payment simply by being waved near a card reader, without the card even being removed from the owner's purse or wallet. Another example is a key fob-style device which is programmed with credit or debit card information, and which can be waved near a gas pump to pay for fuel. These and other similar devices can provide a convenience for consumers, and speed up payment transactions, which is beneficial to merchants, while still maintaining the security of the transaction and the card account by virtue of the very short range over which the signal will travel.

Many modern vehicles include one or more wireless communication technologies as well. Vehicles may include very short-range wireless technologies, such as NFC, which is often used for the payment applications described above. Vehicles also commonly include wireless communication technologies with a longer range, such as built-in cellular phones, satellite-based driver assistance systems, and DSRC or Wi-Fi systems. These systems can make the driving experience safer, more convenient, and more enjoyable for the driver. While cell phones and satellite-based systems have been popular features in vehicles for many years, DSRC systems are expected to rapidly gain in popularity and availability, as DSRC will be a standard technology for the Intelligent Transportation System and many safety applications. DSRC systems are available for vehicle-to-vehicle (V2I) and vehicle-to-infrastructure (V2X) applications, both safety-related and otherwise.

Despite the advances in the use of wireless communications technology in the areas noted above, opportunities still exist to develop the capabilities further. A significant benefit could be provided to drivers by extending the secure payment transaction capabilities of NFC to operate with the vehicle-to-infrastructure environment of DSRC, thus allowing payments to be made from the safety and security of a vehicle, even while the vehicle is moving.

### SUMMARY OF THE INVENTION

In accordance with the teachings of the present invention, a method and system are disclosed for making payments for toll roads, parking, fast food, or other products or services, from a vehicle using a combination of wireless technologies. The method includes allowing a driver to use a contactless smart card, cell phone, or any other device which is equipped with a Near Field Communication (NFC) tag and which may serve as a source of funds, to pay for a product or service without leaving the vehicle or even rolling down a window. The driver authenticates the NFC-enabled source of funds with the vehicle, either in a transaction-by-transaction mode, or a pre-payment mode. The vehicle then communicates with public or private infrastructure pay points via a wireless communications technology, such as Dedicated Short Range Communications (DSRC), to authorize individual payments. This can even be done while the vehicle is moving, such as by driving through an express lane for a toll road or bridge.

Additional features of the present invention will become apparent from the following description and appended claims, taken in conjunction with the accompanying drawings.

### BRIEF DESCRIPTION OF THE DRAWINGS

FIG. 1 is a block diagram of a vehicle to infrastructure architecture;

FIG. 2 is an illustration of a vehicle approaching a toll booth, with DSRC communication between the two;

FIG. 3 is a process flow diagram describing DSRC communication between the vehicle and toll booth shown in FIG. 2; and

FIG. 4 is a partial interior view of a vehicle showing how a driver would interface with onboard systems to authorize payments.

### DETAILED DESCRIPTION OF THE EMBODIMENTS

The following discussion of the embodiments of the invention directed to a system and method for making payments using onboard vehicle wireless communication technologies is merely exemplary in nature, and is in no way intended to limit the invention or its applications or uses.

Wireless communication systems have become an important part of everyday life. Modern vehicles have embraced this trend by incorporating onboard wireless communication systems—both systems which are fully embedded in the vehicle and systems which can link with portable consumer electronic devices carried by a driver or passenger. Integrated cell phones and satellite-based safety and information systems are common in many vehicles today. Other relatively new technologies known as Dedicated Short Range Communications (DSRC) and Near Field Communication (NFC) are also beginning to penetrate the vehicle market.

Dedicated Short Range Communications (DSRC) are one-way or two-way short-range to medium-range wireless communication channels specifically designed for automotive use. Regulatory authorities in the United States, Europe, and elsewhere have allocated a bandwidth spectrum in the 5.9 GHz (GigaHertz, or 10⁹ cycles/second) frequency band for DSRC, to be used by the Intelligent Transportation Systems (ITS). The decision to use the spectrum in the 5.9 GHz frequency range is due to its spectral environment and propagation characteristics, which are suited for vehicular environments. Waves propagating in this spectrum can offer high data rate communications for suitably long distances, up to 1000 meters, with low weather dependence. DSRC can be used in both public safety and private operations, in vehicle-to-vehicle and vehicle-to-infrastructure communication environments. DSRC is meant to be a complement to cellular communications by providing very high data transfer rates in circumstances where minimizing latency in the communication link and isolating relatively small communication zones are important. Alternatively, standard Wi-Fi systems can be used in place of the DSRC for many applications with only a minor reduction in overall system performance.

Another wireless technology which is rapidly gaining acceptance is Near Field Communication (NFC). NFC is a very-short-range wireless connectivity technology that evolved from a combination of existing contactless identification and interconnection technologies. Products with built-in NFC can simplify the way consumer devices interact with one another, helping speed connections, receive and share information, and make fast and secure payments. Operating at 13.56 MHz (MegaHertz, or 10⁶ cycle/sec), and transferring data at up to 424 Kilo-bits per second, NFC provides intuitive, simple, and safe communication between electronic devices. NFC is both a “read” and “write” technology. Communication between two NFC-compatible devices occurs when they are brought within about two to four centimeters of one another. A simple wave or touch can establish an NFC connection, which is then compatible with other known wireless technologies, such as Bluetooth, Wi-Fi, or DSRC. The underlying layers of NFC technology follow universally implemented standards of the International Organization for Standardization (ISO) and other standards organizations. Because the transmission range is so short, NFC-enabled transactions are inherently secure. Also, physical proximity of the device to the reader gives users the reassurance of being in control of the process. NFC can be used with a variety of devices, from mobile phones that enable payment or transfer information to digital cameras that send their photos to a TV set with just a touch. NFC read-only tags are very inexpensive, and are small enough to be placed almost anywhere. The NFC tag is a passive device with no internal power source of its own. When an NFC tag is used, a user passes an NFC enabled reader/writer device near the NFC tag, or vice versa. A small amount of power is taken by the NFC tag from the reader/writer to power the tag electronics. The tag is then enabled to transfer a small amount of information to the reader/writer. Many Bluetooth enabled devices, such as cell phones, now include NFC reader/writer capability, and contactless “smart” credit and debit cards may include an NFC read-only tag which contains account information.

In any typical purchase transaction, a consumer must present some form of payment to a retailer from whom the consumer is purchasing a product or service. The payment could be in the form of cash, a credit or debit card, a mobile phone with fund transfer capability, or otherwise. However, the goal of the present invention is to avoid the direct face-to-face interaction between the consumer and the retailer, to allow the consumer to remain within his or her vehicle, to securely authorize a payment through the vehicle's information systems, while the vehicle is moving or is stationary, and allow the vehicle to wirelessly conduct a payment transaction with the retailer.

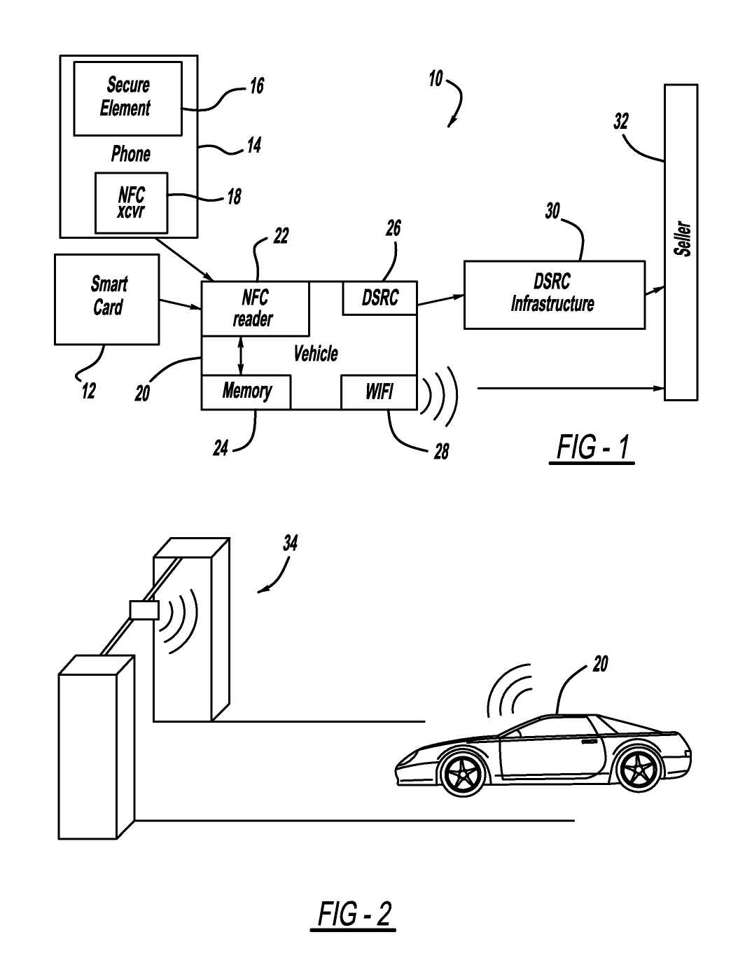

FIG. 1 is a block diagram of a vehicle-to-infrastructure architecture 10. The consumer would provide a source of funds in the form of a contactless smart card 12, or a mobile phone 14, which includes fund transfer capability. The contactless smart card 12 is a credit or debit card with a built-in electronic chip or tag which enables wireless transfer of account information, usually using either Radio Frequency Identification (RFID) or Near Field Communication (NFC) technology. The mobile phone 14 can include fund transfer capability in one of at least two possible modes—including making purchases through an account with the wireless carrier, and using the phone as a surrogate for a regular credit card, debit card, or other secure element 16. In either case, the mobile phone 14 can serve as a source of funds to complete a purchase. The phone 14 must have NFC capability in the form of an NFC transceiver 18.

Onboard a vehicle 20, an NFC reader 22 is needed to wirelessly read the payment account information from either the smart card 12 or the phone 14. The vehicle 20 can store the payment account information in memory 24, for later use if appropriate. The vehicle 20 must also be equipped with a radio transceiver, such as a DSRC radio 26, for wirelessly communicating with the public or private infrastructure. It is envisioned that DSRC transceivers will be standard equipment in many vehicles in the near future, to allow the vehicles to take advantage of Intelligent Transportation System capabilities. In another embodiment, the wireless transceiver could be a Wi-Fi radio 28, or some other type of radio. The DSRC radio 26 can communicate with any entity which has its own DSRC communications capability or is connected to the DSRC infrastructure 30, including both public services and private enterprises. These entities, shown generically as a seller 32, could include retailers such as fast food restaurants, public infrastructure pay points such as toll booths, or any other operation which is set up for drive-thru payment for goods or services.

FIG. 2 shows the vehicle 20 approaching a toll booth 34 which represents the seller 32 described previously. FIG. 3 is a flow chart diagram 40 showing the communication between the vehicle 20 and the toll booth 34. At box 42, the toll booth 34 recognizes the vehicle 20 approaching with DSRC capability. At box 44, the toll booth 34 anticipates the customer's intent to pass through the toll booth 34, based on the vehicle's position and velocity. At box 46 the toll booth 34 notifies the vehicle 20 of the cost of passage. This communication would take place between the DSRC infrastructure 30 and the vehicle's DSRC radio 26. The vehicle 20 would then notify the customer of the payment request at box 48. The driver would authorize the payment if so desired at box 50, the payment transaction would be completed wirelessly at box 52, and the vehicle 20 would be permitted passage through the toll booth 34 without stopping. The toll authority would then process the payment transaction with the appropriate credit card company, just as would be done for any other credit card purchase.

Although systems are currently available which allow automatic payment of road and bridge tolls, these systems require a dedicated hardware device onboard the vehicle. A key advantage to the present invention is that it eliminates the need for extra purpose-dedicated hardware, and instead leverages the DSRC and other systems already onboard the vehicle.

Other use cases can be readily envisioned. Examples include automatic payment for entrance to parks, and payment for drive-thru food purchases without the customer having to handle cash or even lower a window, which is an advantage for personal security or comfort in the case of adverse outside weather conditions. All of these use cases would take advantage of the existing DSRC communication capabilities of the vehicle to make payment transactions faster and easier for the driver.

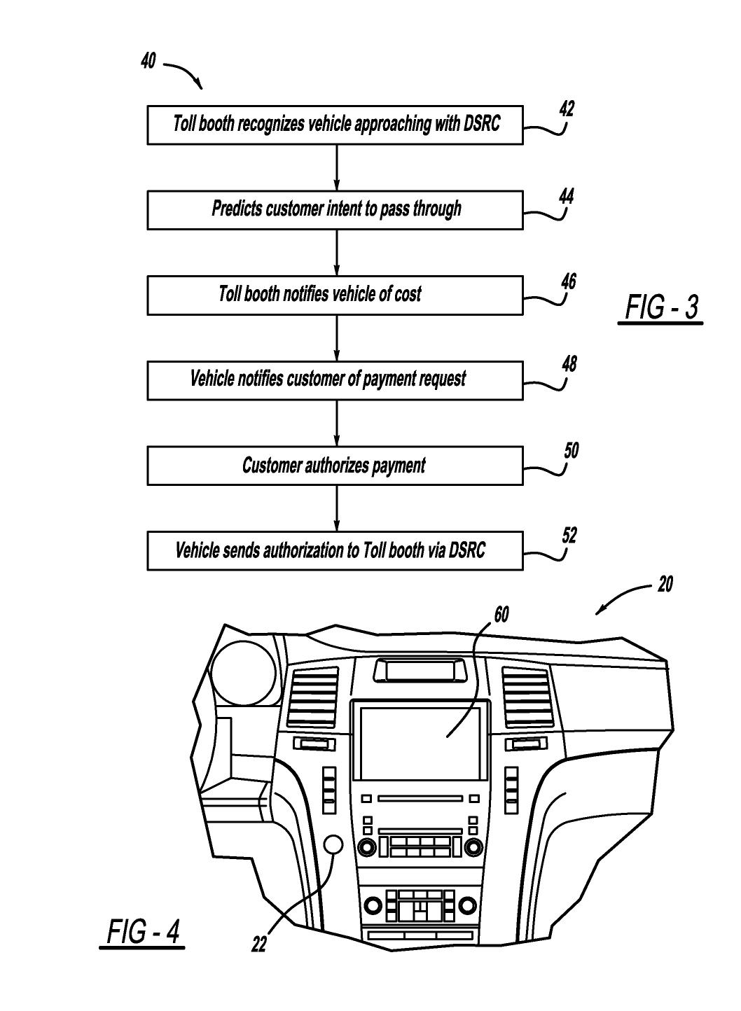

FIG. 4 is a partial interior view of the vehicle 20, showing how a driver would interact with the onboard systems to approve a payment. In the flow chart diagram 40 described previously, a point is reached where the vehicle 20 must notify the customer of a payment request, and the customer must authorize the payment. A touch-screen information system and display 60, of the type commonly found on modern vehicles, displays the payment request information as shown. The content of the display could vary based on the type of purchase, but at a minimum the display would include the amount of the payment request, and touch-screen buttons to accept or decline the payment. In addition, the customer must provide a source of funds. As described previously, either the smart card 12 or the phone 14 could be used for this purpose. The card 12 or the phone 14 must have NFC capability to transmit its charge account information. The card 12 or the phone 14 would be waved past the NFC reader 22, which would be placed in a convenient location in the vehicle interior or even behind the touch-screen display 60 itself. The combination of accepting the payment request on the touch-screen display 60, and waving the card 12 or the phone 14 past the NFC reader 22, would serve as customer authorization of the payment. At that point, the vehicle 20 would send payment authorization to the seller, and the transaction would be completed.

It would also be possible for the customer to set up an account with an allocation of funding, and this account would be pre-approved for a prescribed type of purchase transaction. This method could be used by a driver who regularly passes through a certain toll booth, or who regularly parks in a certain parking lot or garage, for example. With this method, no waving of the card 12 or the phone 14 past the NFC reader 22 is required for each individual payment, since the funding has already been allocated. Pre-approvals could be established with a total account funding allocation, a per-transaction limit, and other parameters. In the simplest case, no customer action at all would be required for an individual payment, as the touch-screen 60 would simply display the amount of a current charge, along with account balance information. When setting up a pre-approved account, the customer could also elect to be prompted to accept or decline each payment request, as shown previously on the screen 60.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A method for making payments from a vehicle, said method comprising:
establishing a wireless communications channel between a vehicle and a seller;
requesting to make a purchase from the seller by a customer in the vehicle;
wirelessly communicating from the seller to the vehicle a payment amount required for the purchase;
notifying the customer of the payment amount by the vehicle;
providing an electronic source of funds within the vehicle;
approving the payment amount within the vehicle; and
wirelessly sending a payment authorization from the vehicle to the seller.

2. The method of claim 1 wherein providing an electronic source of funds includes passing a payment device with Near Field Communication capability near a Near Field Communication reader in the vehicle.

3. The method of claim 2 wherein the payment device is a mobile phone, a credit card, or a debit card.

4. The method of claim 1 further comprising pre-approving a certain type of payment by the customer, and storing data about the pre-approval and data about the source of funds in a memory module in the vehicle.

5. The method of claim 1 wherein establishing the wireless communications channel includes using Dedicated Short Range Communications.

6. The method of claim 5 wherein the seller is a toll booth.

7. The method of claim 6 wherein requesting to make a purchase includes automatically detecting an approaching vehicle with a Dedicated Short Range Communications radio and anticipating the intention of the customer to pass through the toll booth.

8. The method of claim 1 wherein the seller is a restaurant or food vendor with drive-thru service.

9. A method for making payments from a vehicle, said method comprising:
establishing a wireless communications channel between a vehicle and a seller using Dedicated Short Range Communications;
requesting to make a purchase from the seller by a customer in the vehicle;
wirelessly communicating from the seller to the vehicle a payment amount required for the purchase;
notifying the customer of the payment amount by the vehicle;
providing an electronic source of funds within the vehicle by the customer passing a credit card, a debit card, or a mobile phone with Near Field Communication capability near a Near Field Communication reader in the vehicle;
approving the payment amount within the vehicle by the customer; and
wirelessly sending a payment authorization from the vehicle to the seller.

10. The method of claim 9 further comprising pre-approving a certain type of payment by the customer, and storing data about the pre-approval and data about the source of funds in a memory module in the vehicle.

11. The method of claim 9 wherein the seller is a toll booth, and requesting to make a purchase includes automatically detecting an approaching vehicle with a Dedicated Short Range Communications radio and anticipating the intention of the customer to pass through the toll booth.

12. A system for making payments from a vehicle, said system comprising:
a vehicle radio in the vehicle for wirelessly communicating with a seller;
a seller radio at a seller location for wirelessly communicating with the vehicle;
a touch-screen system in the vehicle for allowing a customer to review and approve payments;
a short-range wireless receiver in the vehicle for reading payment account information from a source of funds; and
a controller in the vehicle for sending and receiving messages over the vehicle radio to and from the seller, receiving information from the short-range wireless receiver, displaying information to and receiving inputs from the touch-screen, and managing payment approvals.

13. The system of claim 12 further comprising a memory module for storing information about the source of funds.

14. The system of claim 13 wherein the controller, touch-screen, and memory module in the vehicle also allow the customer to create a pre-approved account for a certain type of payment.

15. The system of claim 12 wherein the short-range wireless receiver in the vehicle is a Near Field Communication reader.

16. The system of claim 15 wherein the source of funds is a credit card or debit card with Near Field Communication capability.

17. The system of claim 15 wherein the source of funds is a mobile phone with Near Field Communication capability.

18. The system of claim 12 wherein the vehicle radio and the seller radio are both Dedicated Short Range Communications radios.

19. The system of claim 12 wherein the seller is a toll booth.

20. The system of claim 19 further comprising an architecture at the toll booth for automatically detecting an approaching vehicle with a Dedicated Short Range Communications radio, communicating to the vehicle a required toll payment amount, completing a payment transaction with the vehicle, and allowing the vehicle to pass the toll booth without stopping.
